(19) United States
(12) Patent Application Publication
(10) Pub. No.: US 2026/0353385 A1
(43) Pub. Date: Nov. 5, 2026

(54) UNUSED TRANSMISSION OCCASIONS USAGE

(71) Applicant: Lenovo (Singapore) Pte. Limited, Singapore (SG)

(72) Inventors: Joachim Löhr, Wiesbaden (DE); Hossein Bagheri, Urbana, IL (US); Vijay Nangia, Woodridge, IL (US)

(73) Assignee: Lenovo (Singapore) Pte. Limited, Singapore (SG)

(21) Appl. No.: 19/150,315

(22) PCT Filed: Dec. 19, 2023
(86) PCT No.: PCT/IB2023/062954

§ 371 Date: Jul. 23, 2025

Related U.S. Application Data
(60) Provisional application No. 63/481,210, filed on Jan. 24, 2023.

(51) Int. Cl. H04W 72/1268; H04W 72/0453; H04W 72/21; H04W 72/543

(52) U.S. Cl. CPC H04W 72/1268; H04W 72/0453; H04W 72/21; H04W 72/543

(57) ABSTRACT

Various aspects of the present disclosure relate to an apparatus for unused transmission occasions usage. The apparatus, such as a UE, generates a medium access control (MAC) protocol data unit (PDU) for uplink transmission on configured uplink grant resources, where the MAC PDU includes at least one packet data convergence protocol (PDCP) service data unit (SDU) of a group of logical channels. The UE cancels the uplink transmission of the MAC PDU on the configured uplink grant resources based at least in part on the MAC PDU includes only a predefined data type.

### RELATED APPLICATION

This application claims priority to U.S. Provisional Application Ser. No. 63/481,210 filed Jan. 24, 2023 entitled “Unused Transmission Occasions Usage,” the disclosure of which is incorporated by reference herein in its entirety.

### TECHNICAL FIELD

The present disclosure relates to wireless communications, and more specifically to transmission resources in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, large video frame data sizes may require more than one physical uplink shared channel (PUSCH) occasion to be transmitted, such as multiple PUSCH occasions per video frame may be needed for transmission, depending on the channel condition and the video frame size. A conventional technique is to configure multiple PUSCH occasions within a configured grant (CG) period. Alternatively, a UE can be configured with multiple CG configurations for uplink transmission. However, the CG resource is semi-statically configured and not adaptable to the varying size of video frames, such as the video frames typically associated with extended reality (e.g., virtual reality and/or augmented reality). Currently, a UE will perform a CG PUSCH transmission if there is data available for the uplink transmission even when the latency requirement of the data included in the medium access control (MAC) protocol data unit (PDU) and transport block has already been exceeded. Generally, a UE will perform a CG PUSCH transmission even for data which is of no use for the application layer and respective user experience, which leads to increased power consumption and reduced system capacity.

### SUMMARY

The present disclosure relates to methods, apparatuses, and systems that support unused transmission occasions usage. Techniques are described to avoid unnecessary uplink transmissions on configured uplink grant resources, thereby optimizing the battery lifetime and increasing the resource efficiency and capacity. In particular, the described techniques provide for skipping CG PUSCH transmissions of outdated data, an indication of unused resources for cases where a CG PUSCH is skipped due to PDU set delay budget (PSDB) having been exceeded, and CG PUSCH transmission with reduced transmission power for cases when data is already beyond its latency requirement. For cases when a MAC PDU contains only data for which the latency requirement is already exceeded (e.g., a corresponding packet data convergence protocol (PDCP) discard timer is expired) a UE skips the transmission of the MAC PDU on the CG PUSCH resources. Further, the UE can indicate the CG PUSCH resources as being unused resources, thus allowing gNB allocation of the resources to other uplink transmissions and/or UEs.

In aspects of the described techniques for unused transmission occasions usage, a UE skips the uplink transmission on a configured grant uplink resource (e.g., CG PUSCH) for cases when the transmission would contain data which has already failed its quality of service (QoS) requirement (e.g., exceeded the associated latency requirement, such as PSDB or packet delay budget (PDB)). According to an implementation, the UE does not perform an uplink transmission on a configured uplink grant (i.e., CG PUSCH) when the transmission contains only data for which the latency requirement is exceeded (e.g., the discard timer of the corresponding PDCP service data units (SDUs) contained in the transport block is expired). Rather than transmitting data, which is of no use for the user experience, the UE skips the uplink transmission in order to reduce the battery consumption and to free-up transmission resource. Alternatively, a UE can transmit a transport block (TB) containing data for which the latency requirement is already exceeded or for which the data is of no use for the user experience with a reduced transmission power. According to an implementation, the UE scales down the transmission power by a predefined factor for a CG PUSCH transmission for cases when the data of the TB is outdated or obsolete, which also conserves device battery power.

In some implementations of the method and apparatuses described herein, a UE generates a medium access control (MAC) protocol data unit (PDU) for uplink transmission on configured uplink grant resources, where the MAC PDU includes at least one PDCP SDU of a group of logical channels. The UE also cancels the uplink transmission of the MAC PDU on the configured uplink grant resources based at least in part on the MAC PDU includes only a predefined data type.

Some implementations of the method and apparatuses described herein may further include the UE determines that the MAC PDU includes data that has exceeded a latency requirement. The UE determines that the MAC PDU includes data of a PDU set that has lost at least one PDU. The UE determines that the MAC PDU includes data that fails a quality of service (QoS) requirement. The UE determines that the MAC PDU includes the predefined data type based at least in part on a PDCP discard timer associated with PDCP SDUs multiplexed in the MAC PDU has expired. The UE determines that the MAC PDU includes the predefined data type based at least in part on an estimation that a PDCP discard timer will expire before a CG PUSCH transmission occasion. The UE transmits a signaling as a control message to a next-generation NodeB (gNB) on configured uplink resources in response to canceling the uplink transmission of the MAC PDU on the configured uplink grant resources. The signaling of the control message is transmitted via uplink control information (UCI) or a MAC control element (CE). The control message includes an indication that the configured uplink grant resources are unused. The indication is a cause value that indicates at least one of PSDB exceeded, PDU loss, or no data availability. The control message includes an indication that the MAC PDU includes only the predefined data type. The predefined data type is unused data based on one of exceeded a latency requirement, or lost at least one PDU of a PDU set. The UE flushes a transmission buffer in response to canceling the uplink transmission of the MAC PDU on the configured uplink grant resources. The UE receives, from a gNB, a signaling as a transmission configuration indicating to skip a CG PUSCH transmission occasion of at least one of the predefined data type or a transport block that includes one of outdated data or obsolete data.

In some implementations of the method and apparatuses described herein, a gNB transmits a first signaling to a UE as a transmission configuration indicating to skip a CG PUSCH transmission occasion of outdated data or obsolete data. The gNB also receives a second signaling as a control message indicating that the UE canceled an uplink transmission of a MAC PDU on configured uplink grant resources based at least in part on the transmission configuration.

Some implementations of the method and apparatuses described herein may further include the second signaling of the control message is received via UCI or a MAC CE in a first CG PUSCH transmission occasion. The control message includes an indication that the configured uplink grant resources are unused. The indication is a cause value that indicates at least one of PSDB exceeded, PDU loss, or no data availability. The control message includes an indication that the MAC PDU includes unused data based on the unused data has one of exceeded a latency requirement, or lost at least one PDU of a PDU set. The gNB schedules one or more other uplink transmissions utilizing unused resources of the configured uplink grant resources. The one or more other uplink transmissions utilizing the unused resources of the configured uplink grant resources are scheduled for the UE or a different UE.

### BRIEF DESCRIPTION OF THE DRAWINGS

FIG. 1 illustrates an example of a wireless communications system that supports unused transmission occasions usage in accordance with aspects of the present disclosure.

FIG. 2 illustrates an example of scenario for UCI indicating unused transmission occasions, as related to unused transmission occasions usage in accordance with aspects of the present disclosure.

FIG. 3 illustrates an example of a physical uplink control channel (PUCCH) resource with CG-UCI indicating if TB transmission occurs in CG configurations, as related to unused transmission occasions usage in accordance with aspects of the present disclosure.

FIG. 4 illustrates an example of transmission occasions, where each PDCP and radio link control (RLC) PDU is associated with a CG PUSCH transmission occasion according to logical channel (LCH) mapping configurations, which supports unused transmission occasions usage in accordance with aspects of the present disclosure.

FIGS. 5 and 6 illustrate an example of a block diagram of devices that supports unused transmission occasions usage in accordance with aspects of the present disclosure.

FIGS. 7-10 illustrate flowcharts of methods that support unused transmission occasions usage in accordance with aspects of the present disclosure.

### DETAILED DESCRIPTION

With reference to CG in a wireless communications system, an uplink data transmission (e.g., a PUSCH) may be scheduled with downlink control information (DCI) on a physical downlink control channel (PDCCH), or a semi-static configured grant may be provided over radio resource control (RRC), where two types of operations are supported. The first PUSCH is triggered with a DCI, with subsequent PUSCH transmissions following the RRC configuration and scheduling received on the DCI, or the PUSCH is triggered by data arrival at the transmit buffer of a UE and the PUSCH transmissions follow the RRC configuration. For a configured grants operation with shared spectrum channel access, a configured grant uplink control information (CG-UCI) can be transmitted in a PUSCH scheduled by configured uplink grant.

With reference to multiple occasions within a CG period, large video frame sizes may require more than one PUSCH occasion to be transmitted, such as multiple PUSCH occasions per video frame may be needed for transmission, depending on the channel condition and the video frame size. A conventional technique is to configure multiple PUSCH occasions within a CG period. However, the CG resource is semi-statically configured and cannot adapt to the varying size of video frames, such as the video frames typically associated with extended reality (e.g., virtual reality and/or augmented reality). If a quantity of configured resources is not sufficient for transmission of a video frame, some scheduling delay associated with the dynamic scheduling could occur for scheduling the rest of the video frame that was not included in the configured resources.

In aspects of unused transmission occasions usage, this disclosure describes that, in order to avoid extra delays caused by additional dynamic scheduling, the CG resource within one CG period can be configured according to a relatively large size for transmission of a video frame. When the video frame arrives at a buffer of a UE, the UE can determine how much resource out of the configured resources within one CG period is needed, and can indicate the unused quantity of resources to a gNB so that the gNB schedules other uplink transmissions for the same UE or for a different UE in at least some of the unused resources. The indication from the UE to the gNB can be via UCI or MAC CE, and can be transmitted in the first CG PUSCH occasion. Note that the indication from the UE to the gNB can optionally indicate unused CG occasions and/or resources associated with multiple configured configurations (e.g., in one CG period or in multiple CG periods).

In further aspects of this disclosure, techniques are described to avoid unnecessary uplink transmissions on configured uplink grant resources, thereby optimizing the battery lifetime and increasing the resource efficiency and capacity. In particular, the described techniques provide for skipping CG PUSCH transmissions of outdated data, an indication of unused resources for cases where a CG PUSCH is skipped due to PSDB having been exceeded, and CG PUSCH transmission with reduced transmission power for cases when data is already beyond its latency requirement. Notably, the terms CG transmission occasions, CG resources, and PUSCH occasions can be used interchangeably throughout the disclosure.

By utilizing the described techniques, a UE can skip a CG PUSCH transmission, or alternatively, perform CG PUSCH transmission with reduced transmission power. In one or more implementations, a UE skips CG PUSCH transmission if PDUs are outdated (e.g., PSDB is expired), and/or the UE skips the CG transmission based on an estimate that the discard timer is expired before transmission occasion and indicating to the physical layer (PHY) not to transmit. The UCI indicates a reason why PDB has expired. A gNB can configure whether the UE shall skip CG PUSCH transmission containing outdated or obsolete data. A new categorization of TBs can be indicated as outdated or obsolete TBs, in addition to deprioritized TBs and/or CGs. The PHY can indicate acknowledgement (ACK) to medium access control (MAC) when skipping a CG PUSCH transmission. Additionally, the UE may flush the hybrid automatic repeat-request (HARQ) buffer and provide an indication to radio link control (RLC) and/or packet data convergence protocol (PDCP) that PDUs are successfully transmitted (e.g., via a local or internal RLC status report and an internal PDCP status report). In one or more alternate implementations, a UE performs CG PUSCH transmission with reduced transmission power to transmit outdated data (e.g., the delay budget is exceeded) and can indicate the outdated data as being unused or outdated (e.g., with no need to decode).

In other aspects of the described techniques for unused transmission occasions usage, one or more rules for skipping CG PUSCH transmissions can be implemented. For example, CG is restricted for extended reality (XR) data traffic, where buffer status reporting (BSR) is related only to the XR data traffic, and XR BSR MAC CE indicates no data availability for any logical channel group (LCG) or for any XR LCG. A skipping rule for additional CG PUSCH resources can be different for a primary CG PUSCH resource. For example, the MAC CE should not be communicated on the CG PUSCH resource alone, but rather the transmission is skipped, since the additional PUSCH resources are meant to be used only for data (e.g., based new transmission skipping rules).

Aspects of the present disclosure are described in the context of a wireless communications system. Aspects of the present disclosure are further illustrated and described with reference to device diagrams and flowcharts.

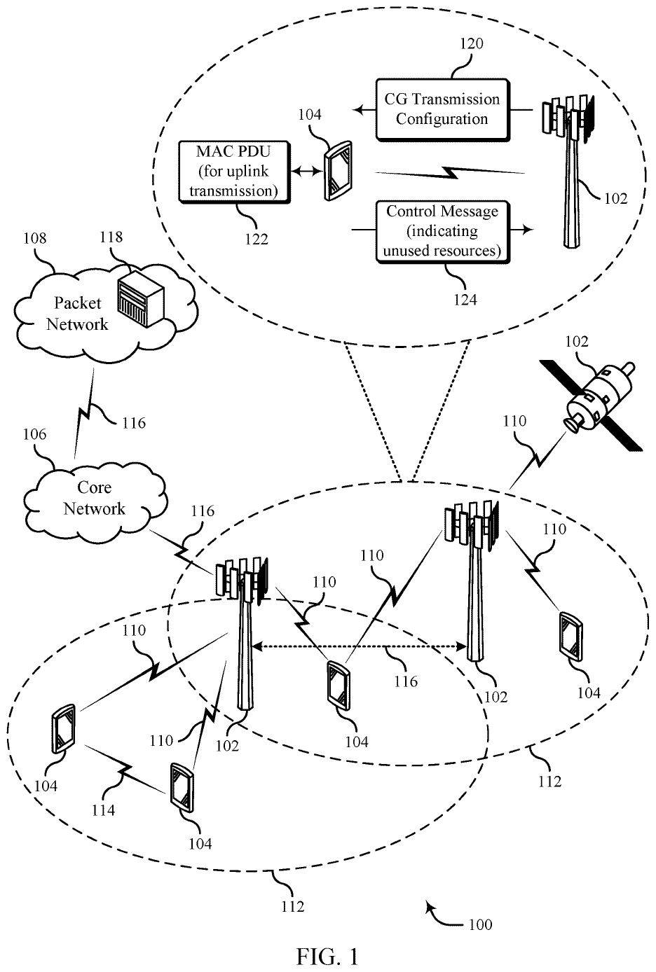

FIG. 1 illustrates an example of a wireless communications system 100 that supports unused transmission occasions usage in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of unused transmission occasions usage, as described herein. For instance, a network entity 102 (e.g., a gNB, base station) communicates, to a UE 104, a CG transmission configuration 120 indicating to skip a CG PUSCH transmission occasion of outdated data or obsolete data. The UE generates a MAC PDU 122 for uplink transmission on configured uplink grant resources, where the MAC PDU includes at least one PDCP SDU of a group of logical channels. The UE also cancels the uplink transmission of the MAC PDU on the configured uplink grant resources based on the MAC PDU includes only a predefined data type, such as the data has exceeded a latency requirement, the data has lost at least one PDU of a PDU set, the data fails a QoS requirement, the predefined data type is based on a PDCP discard timer associated with PDCP SDUs multiplexed in the MAC PDU has expired, and/or the predefined data type is based on an estimation that a PDCP discard timer will expire before a CG PUSCH transmission occasion. The UE transmits a control message 124 to the network entity 102 (e.g., the gNB) on configured uplink resources in response to canceling the uplink transmission of the MAC PDU on the configured uplink grant resources. The control message includes an indication that the configured uplink grant resources are unused.

With reference to CG, an uplink data transmission (e.g., a PUSCH) may be scheduled with DCI on a PDCCH, or a semi-static configured grant may be provided over RRC, where two types of operations are supported. The first PUSCH is triggered with a DCI, with subsequent PUSCH transmissions following the RRC configuration and scheduling received on the DCI, or the PUSCH is triggered by data arrival at the transmit buffer of a UE and the PUSCH transmissions follow the RRC configuration. For a configured grants operation with shared spectrum channel access, a CG-UCI can be transmitted in a PUSCH scheduled by configured uplink grant.

As indicated above, and with reference to multiple occasions within a CG period, large video frame data sizes may require more than one PUSCH occasion to be transmitted, such as any number (e.g., one to five) of PUSCH occasions per video frame may be needed for transmission, depending on the channel condition and the video frame size. A conventional technique is to configure multiple PUSCH occasions within a CG period, such as in the approach supported for shared spectrum. For resource allocation for uplink transmission with CG, a set of allowed periodicities P are defined. The higher layer parameter cg-nrofSlots provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration. The uplink grant received on the DCI for Type 2 PUSCH transmissions, and the remaining PUSCH allocations, have the same length and PUSCH mapping type, and are appended following the previous allocations without any gaps. The same combination of start symbol and length, and PUSCH mapping type, repeats over the consecutively allocated slots.

However, the CG resource is semi-statically configured and cannot adapt to the varying size of video frames, such as the video frames typically associated with extended reality (e.g., virtual reality and/or augmented reality). If a quantity of configured resources is not sufficient for transmission of a video frame, some scheduling delay associated with the dynamic scheduling could occur for scheduling the rest of the video frame that was not included in the configured resources. In order to avoid extra delays caused by additional dynamic scheduling, the CG resource within one CG period can be configured according to a relatively large size for transmission of a video frame. When the video frame arrives at a buffer of a UE, the UE can determine how much resource out of the configured resources within one CG period is needed, and can indicate the unused quantity of resources to a gNB so that the gNB schedules other uplink transmissions for the same UE or for a different UE in at least some of the unused resources. The indication from the UE to the gNB can be via UCI or MAC CE, and can be transmitted for example in the first CG PUSCH occasion. Note that the indication from the UE to the gNB can optionally indicate unused CG occasions and/or resources associated with multiple configured configurations (e.g., in one CG period or in multiple CG periods).

In aspects of this disclosure, dynamic indication of the unused CG PUSCH occasion(s) based on UCI (e.g., CG-UCI or a new UCI) by the UE is taken into consideration. In further aspects of this disclosure, multiple CG PUSCH transmission occasions in a period of a single CG PUSCH configuration is taken into consideration.

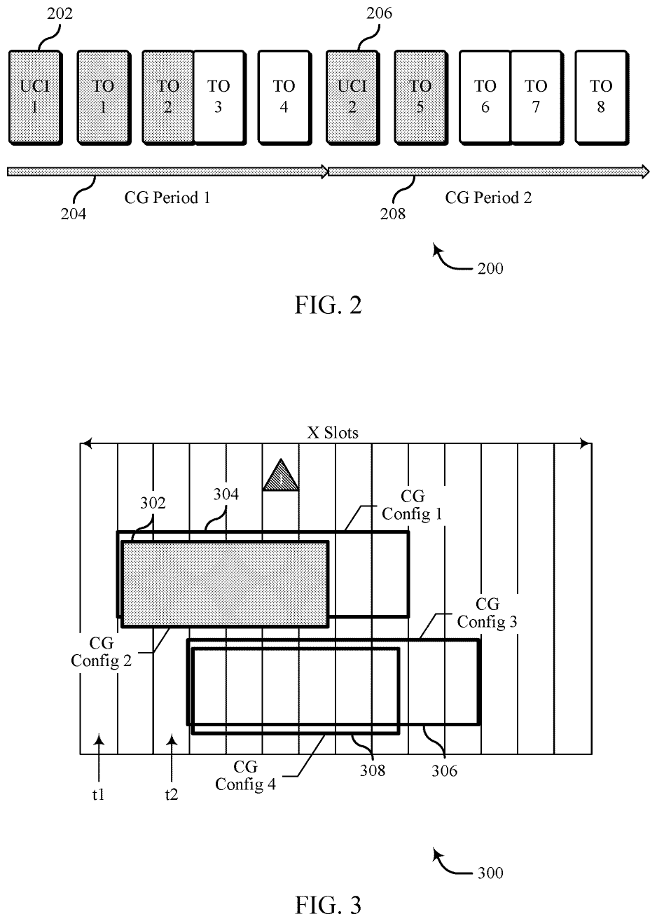

FIG. 2 illustrates an example 200 for UCI indicating unused transmission occasions, as related to unused transmission occasions usage. For instance, a UCI in a CG transmission occasion of a CG configuration can be used to indicate unused transmission occasions of the CG configuration within one period of the CG configuration, such as illustrated in this example. In this example 200, UCI indicates unused transmission occasions (TOs). In a first UCI 202 within a CG period 1 at 204, a UE can indicate unused transmission occasions TO3 and TO4 out of the transmission occasions TO1-TO4, and in a second UCI 206 within a CG period 2 at 208, the UE can indicate unused transmission occasions TO6, TO7, and TO8 out of the transmission occasions TO5-TO8.

With reference to an indication of unused transmission occasions within one period of a CG configuration, prior techniques propose that an UCI in a CG transmission occasion of a CG configuration indicate unused transmission occasions of that CG configuration within one period of the CG configuration. In contrast, this disclosure provides rules for indicating unused transmission occasions of multiple CG configurations by a UCI.

FIG. 3 illustrates an example 300 of a PUCCH resource with CG-UCI indicating if TB transmission occurs in CG configurations, as related to unused transmission occasions usage. With reference to multiple CG configurations, instead of a CG configuration with multiple PUSCH occasions within a period, multiple CG configurations each providing one PUSCH occasion can be used to accommodate varying packet size (e.g., from one video frame to another video frame) by selecting one of the CG configurations to transmit a video frame. A CG-UCI in one of the CG configurations can indicate which CG configuration is used in a time window (e.g., when all of the CGs used for uplink transmission of an XR packet have the same periodicity but different resource duration in time domain). For instance, a UCI in a PUSCH occasion of one of the CGs can indicate which CGs are unused in a period. In this example 300, CG configuration(2) 302 is used, and CG configuration(1) 304, CG configuration(3) 306, and CG configuration(4) 308 have unused PUSCH occasions. This disclosure provides details and generalizations to implement unused transmission occasions usage (e.g., a scheme that includes details of UCI indication, rules when CG configurations overlap in time domain, etc.).

In one or more implementations of unused transmission occasions usage, a UE skips the uplink transmission on a configured grant uplink resource (e.g., CG PUSCH) for cases when the transmission would contain data which has already failed its quality of service (QoS) requirement (e.g., exceeded the associated latency requirement, such as PSDB or PDB). According to an implementation, the UE does not perform an uplink transmission on a configured uplink grant (i.e., CG PUSCH) when the transmission contains only data for which the latency requirement is exceeded (e.g., the discard timer of the corresponding PDCP SDUs contained in the transport block is expired). Rather than transmitting data, which is of no use for the user experience, the UE skips the uplink transmission in order to reduce the battery consumption and to free-up transmission resource.

As agreed for XR-services, it is more suitable to discard an application packet (e.g., a PDU set) before starting to transmit the application packet if it is estimated that the PDU set will not meet the PSDB. In other words, all PDCP SDUs and/or PDUs associated to a PDU set should not be transmitted if an application packet will not meet the agreed QoS (e.g., exceeds the PSDB). Similarly, and according to an implementation, the UE does not perform an uplink transmission on a CG PUSCH for cases that data to be transmitted on the CG PUSCH is of no use for the user experience. For example, at least one PDU of the corresponding PDU set have been determined as “lost” and all PDUs are needed for the usage of the PDU Set by application layer according to the PDU set integrated indication (PSII) signaling and/or configuration.

In an example, the higher layer of the UE (e.g., the PDCP layer) indicates to the physical layer (PHY) that the corresponding PSDB of a PDCP SDU which has already been delivered to lower layer for transmission has been exceeded. In response to receiving the indication, the PHY stops the transmission of the corresponding PDCP SDUs on the CG PUSCH resources (e.g., the UE skips a CG PUSCH transmission containing the corresponding PDCP SDUs). It should be noted that the term “transmission” on a CG PUSCH should not be limited to initial HARQ transmissions on CG PUSCH resources, but may also include HARQ retransmission(s) on a CG PUSCH resource. In an example, a UE does not skip a CG PUSCH transmission for cases that a high priority MAC CE is contained within the TB even when all MAC SDU(s) within the TB are beyond its latency requirement (e.g., PSDB is exceeded).

In one or more implementations, a UE flushes the corresponding HARQ buffer of the HARQ process associated with a CG PUSCH transmission occasion (e.g., the transmission buffer) for cases when the CG PUSCH transmission is skipped (e.g., due to data contained in the corresponding TB which has already exceeded the latency requirement).

In one or more implementations a UE (e.g., PHY layer) reports a local ACK for the corresponding RLC PDUs contained in the TB for which a transmission was skipped due to exceeded latency requirements. Similarly, the UE reports a local ACK for the PDCP PDUs and/or SDUs contained in the TB for which a transmission was skipped on CG PUSCH resources. In the legacy, a RLC ACK/NACK (RLC status report) or PDCP ACK/NACK (PDCP status report) is transmitted by the receiving entity to the transmitting entity. However, in implementations described in this disclosure, the local RLC feedback or PDCP ACK/NACK is reported internally (e.g., information signaling among the different protocol layers of the UE).

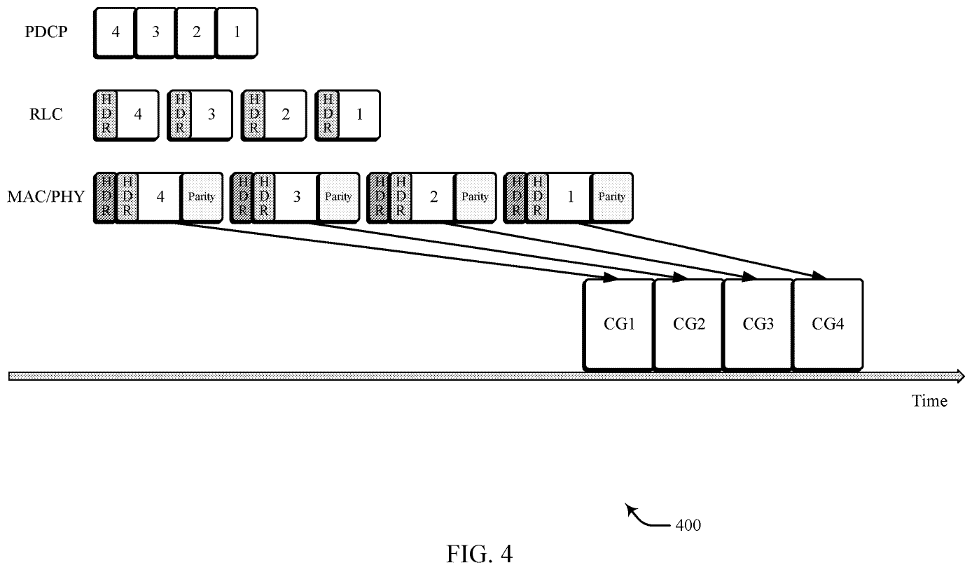

FIG. 4 illustrates an example 400 of transmission occasions, where each PDCP and RLC PDU is associated with a CG PUSCH transmission occasion according to LCH mapping configurations, which supports unused transmission occasions usage in accordance with aspects of the present disclosure. In an example use case, a UE has already assigned sequence numbers (e.g., PDCP/RLC SN) to the PDCP SDUs and delivered the corresponding RLC PDU(s) to the lower layer for transmission (e.g., generation of TB) when the indication about exceeded latency requirement (PSB) is received from the higher layer (e.g., the PDCP layer). As shown in the example 400, PDCP SDUs with sequence numbers SN1-SN4 are delivered to the RLC layer, where corresponding RLC PDUs are generated and delivered to the MAC/PHY for the generation of the transport blocks. Each of the PDCP/RLC PDU is associated with a CG PUSCH transmission occasion by means of the LCH mapping configurations (e.g., referred to as CG1-CG4 in the example 400).

Assuming that the PDCP discard timer for PDCP SN3 and SN4 expires before the transmission on the corresponding CG PUSCH occasions (i.e., CG3 and CG4), the UE will skip the corresponding CG PUSCH transmissions (i.e. the UE does not perform uplink transmission on CG3 and CG4) and optionally, the UE flushes the associated HARQ transmission buffer where the TBs are stored. It should be noted that configured LCH mapping restrictions for the configured grant configuration(s) ensure that only data of specific LCH(s) is transmitted on the CG PUSCH resources (i.e., no multiplexing of data of other LCHs). According to the LCH mapping configurations and/or restriction, the network can ensure that only PDUs belonging to a PDU set are transmitted on the CG PUSCH transmission occasions (e.g., such as for a situation where part of the MAC SDU(s) multiplexed in a TB have exceeded its latency requirement, whereas other MAC SDUs within the TB are still within the PDB can be avoided).

In an example, a UE estimates or predicts that the PDCP discard timer expires before the corresponding transmission occasion (e.g., CG PUSCH occasion) and indicates to the PHY not to perform the corresponding CG PUSCH transmission. Optionally and according to one or more implementations, the UE can stop and not start the generation of the corresponding TB when the indication not to perform the transmission is received from the higher layer (e.g., the CG PUSCH transmission occasion is after the discard timer expiration).

In one or more implementations, the UE indicates CG PUSCH resources as “unused resources” when a CG PUSCH transmission is skipped (e.g., due to exceeding the PSDB). According to an implementation, a new trigger and/or use case for indication of the “unused resources” is introduced in this disclosure. Typically, the usage of the unused resource indication is determined based on data availability in the UE (e.g., upon arrival of a video frame at the buffer of the UE), and the UE can determine an amount of the resources out of the configured resources within one CG period that is needed. The UE can also indicate the unused amount of the resources to a gNB so that the gNB can schedule other uplink transmissions (e.g., for the same UE or for a different UE) in at least some of the unused resources. The indication from the UE to the gNB can be via UCI or MAC CE, and can be transmitted in the first CG PUSCH occasion or in a subsequent CG PUSCH occasion (e.g., if the UE determined that certain CG PUSCH transmissions are skipped for cases where the corresponding transport block contains only outdated data or obsolete data. In an example, an indication from a UE to the gNB (e.g., UCI or MAC CE) within a CG period can overwrite an earlier indication sent from the UE to the gNB within the same CG period. According to this aspect of the disclosure, a new rule for indicating unused CG PUSCH resources within a CG period is defined (e.g.) based on the expiration of a discard timer and/or based on a packet loss).

In one or more implementations, a UE indicates a cause value when indicating unused resources, where for example, the cause value could refer to a set of different causes. According to an implementation, the cause value could indicate any one or more of: “PSDB exceeding” which indicates that the corresponding PSDB of the data was exceeded and hence CG PUSCH transmission is not performed; “PDU loss” which indicates that, since at least one PDU of a PDU set is determined to be “lost”, there is no point in transmitting further remaining PDU(s) of the PDU set; and/or data availability, which indicates that there is no further data in the UE buffer available for transmission

The receiving entity (e.g., a gNB) can assume that no further PDUs of the PDU set are transmitted or received in response to receiving an indication that the CG PUSCH resources are not used by the transmit entity with the cause “PSDB exceeded” or “PDU loss”. In an example, the cause value is signaled together with the unused resources indication in the same signaling message (e.g., UCI or MAC CE). In an implementation, a codepoint or state represents the cause and corresponding unused occasions. For instance, for a CG configuration with four CG transmission occasions within a CG period, three bits can be allocated to a field in the UCI for indicating the unused transmission occasions and the associated cause, such as defined in the following table:

| UCI bit | |
|---|---|
| field value | Unused TOs as well as corresponding cause |
| 000 | All TOs are used, PDU is NOT lost |
| 001 | 4^{th} TO (last TO) is unused, no more data available |
| 010 | 3^{rd} & 4^{th} TOs are unused, no more data available |
| 011 | 2^{nd}, 3^{rd} & 4^{th} TOs are unused, no more data available |
| 100 | 2^{nd}, 3^{rd} & 4^{th} TOs are unused, PSDB exceeded |
| 101 | 2^{nd}, 3^{rd} & 4^{th} TOs are unused, PDU is lost |
| 110 | 3^{rd} & 4^{th} TOs are unused, PSDB exceeded |
| 111 | All TOs are used, PDU is lost |

According to one or more implementations, a new type of uplink grant, transport block, and/or data is introduced (e.g., for outdated data or obsolete data). For example, the outdated or obsolete data refers to PDUs for which the latency requirement has already been exceeded. According to another implementation, the obsolete data refers to PDUs which are of no use for the application layer of the end user and therefore should not be transmitted. According to an implementation, a transport block is considered to be outdated when the discard timer is expired for all MAC SDUs or corresponding PDCP SDUs. Additionally, a specific UE behavior is specified for obsolete and/or outdated data, such as by skipping uplink transmissions on configured grant uplink resources for obsolete data and/or indicating corresponding skipped resources as being unused resources, as described above.

In one or more implementations, a UE receives a configuration indicating whether the UE shall skip CG PUSCH transmission for cases when the corresponding data and/or transport block contains outdated or obsolete data. In an example, the configuration is sent by a gNB to the UE, such as a configuration via RRC signaling, a signal within a CG configuration information element ((I.E.,), or the configuration is signaled within the Logicalchannelconfig IE (e.g., the network configures per LCH whether to skip a CG PUSCH transmission for cases when the data of the LCH is outdated or obsolete).

According to one or more implementations, a UE transmits a transport block containing data for which the latency requirement is already exceeded or for which the data is of no use for the user experience with a reduced transmission power. According to an implementation, the UE scales down the transmission power by a predefined factor for a CG PUSCH transmission for cases when the data of the TB is outdated or obsolete. The definition of outdated or obsolete data is described above. Since the data is of no use for the application or respective user experience (i.e., the data does not improve the quality of experience of the end user or application), it is beneficial for the battery consumption to spend less transmission power for the CG PUSCH transmission than the determined transmission PUSCH according to the power control formula. In contrast to the above described implementations, the CG PUSCH transmission is still performed by the UE for outdated or obsolete data, however with a reduced transmission power. In an example, the predefined factor indicating the transmission power reduction (e.g., a factor smaller than one) is configured per CG configuration (e.g., RRC signaling).

In an example, the UE indicates (e.g., within the CG UCI or a MAC CE) that the corresponding CG PUSCH transmission has been made with a reduced transmission power due to outdated or obsolete data. The receiving entity may use this information for optimizing the corresponding receiving operation (e.g., by not requesting any further retransmission or updating corresponding receiving windows in RLC or PDCP). In another example, the UE signals the CG PUSCH resources as unused resources for cases when the corresponding CG PUSCH transmission is performed with reduced transmission power. In an example, a number of resources (e.g., resource elements) for CG UCI may be computed based on an assumption of no reduction in CG PUSCH transmission power. In another example, the number of resources (e.g., resource elements) for CG UCI may be computed based on the reduced transmission power for CG PUSCH comprising the CG UCI, for example based on the configured predefined factor indicating the transmission power reduction in the associated CG configuration. In yet another example, the CG UCI resources may be computed based on an assumption of no reduction in CG PUSCH transmission power and is repeated a certain number of times based on a repetition factor. The repetition factor may be computed based on the reduced transmission power for CG PUSCH comprising the CG UCI, for example based on the configured predefined factor indicating the transmission power reduction in the associated CG configuration.

In one or more implementations, a UE skips a transmission on a CG PUSCH transmission occasion for cases when the corresponding MAC PDU includes only the periodic BSR and there is no data available for any LCG of a set of predefined LCGs. According to an implementation, the UE skips a CG PUSCH transmission if the MAC PDU includes only a periodic BSR and there is no data availability for any LCH or LCG carrying XR services (e.g., LCG or LCH used for the transmission of XR services. The UE will skip the CG PUSCH transmission even though the periodic BSR indicates some data availability for other non-XR LCHs or LCGs. The assumption is that the CG PUSCH resources are reserved specifically for XR services or LCHs. Therefore, the UE should rather skip a CG PUSCH transmission and indicate the resources as being unused resources when there is no more XR data in the UE buffer, even if there might be some other non-XR data in the buffer available for transmission. It should be noted that, according to the current specifications, a UE will only skip a CG PUSCH transmission for cases when the periodic BSR indicates no data availability for any LCG.

In implementations, the MAC entity shall not generate a MAC PDU for the HARQ entity if the MAC entity is configured with enhancedSkipUplinkTxDynamic with value true and the grant indicated to the HARQ entity was addressed to a cell-radio network temporary identifier (C-RNTI), or if the MAC entity is configured with enhancedSkipUplinkTxConfigured with value true and the grant indicated to the HARQ entity is a configured uplink grant: if there is no UCI to be multiplexed on this PUSCH transmission, if there is no aperiodic channel state information (CSI) requested for this PUSCH transmission, if the MAC PDU includes zero MAC SDUs, and if the MAC PDU includes only the periodic BSR and there is no data available for any LCG, or the MAC PDU includes only the padding BSR. Alternatively, if the MAC entity is configured with skipUplinkTxDynamic with value true and the grant indicated to the HARQ entity was addressed to a C-RNTI, or the grant indicated to the HARQ entity is a configured uplink grant: if there is no aperiodic CSI requested for this PUSCH transmission, if the MAC PDU includes zero MAC SDUs, and if the MAC PDU includes only the periodic BSR and there is no data available for any LCG, or the MAC PDU includes only the padding BSR, then the MAC entity does not generate a MAC PDU for the HARQ entity.

In one or more implementations, a UE skips a CG PUSCH transmission if the MAC PDU contains only a XR BSR which indicates no data availability for any LCG. The assumption for this example being that a XR specific BSR MAC CE exists, which carries only buffer status information for XR services or LCHs. In another example, the UE skips transmission of an instance of a periodic BSR in a CG transmission occasion of a particular CG configuration if the BSR is associated with a first BSR table and does not skip transmission of the periodic BSR if the BSR is associated with a second BSR table (e.g., XR-specific BSR table). In a related example, the particular CG configuration includes more than one CG occasion within a period of the CG configuration, or a UCI is enabled to indicate unused transmission occasions of the CG configuration. In another example, an instance of the periodic BSR is allowed to be transmitted in only the CG transmission occasion in which a CG-UCI is being transmitted.

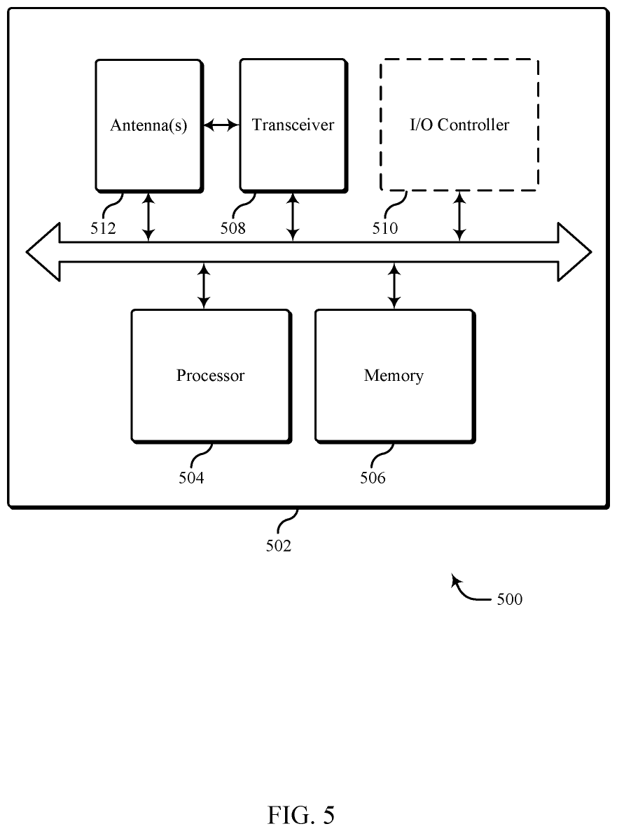

FIG. 5 illustrates an example of a block diagram 500 of a device 502 that supports unused transmission occasions usage in accordance with aspects of the present disclosure. The device 502 may be an example of a UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for generating a MAC PDU for uplink transmission on configured uplink grant resources, the MAC PDU including at least one PDCP SDU of a group of logical channels; and canceling the uplink transmission of the MAC PDU on the configured uplink grant resources based at least in part on the MAC PDU includes only a predefined data type.

Additionally, the processor 504 may be configured as or otherwise support any one or combination of the method further comprising determining that the MAC PDU includes data that has exceeded a latency requirement. The method further comprising determining that the MAC PDU includes data of a PDU set that has lost at least one PDU. The method further comprising determining that the MAC PDU includes data that fails a QoS requirement. The method further comprising determining that the MAC PDU includes the predefined data type based at least in part on a PDCP discard timer associated with PDCP SDUs multiplexed in the MAC PDU has expired. The method further comprising determining that the MAC PDU includes the predefined data type based at least in part on an estimation that a PDCP discard timer will expire before a CG PUSCH transmission occasion. The method further comprising transmitting a signaling as a control message to a gNB on configured uplink resources in response to canceling the uplink transmission of the MAC PDU on the configured uplink grant resources. The signaling of the control message is transmitted via UCI or MAC CE. The control message includes an indication that the configured uplink grant resources are unused. The indication is a cause value that indicates at least one of PSDB exceeded, PDU loss, or no data availability. The control message includes an indication that the MAC PDU includes only the predefined data type. The predefined data type is unused data based on one of exceeded a latency requirement, or lost at least one PDU of a PDU set. The method further comprising flushing a transmission buffer in response to canceling the uplink transmission of the MAC PDU on the configured uplink grant resources. The method further comprising receiving, from a gNB, a signaling as a transmission configuration indicating to skip a CG PUSCH transmission occasion of at least one of the predefined data type or a transport block that includes one of outdated data or obsolete data.

Additionally, or alternatively, the device 502, in accordance with examples as disclosed herein, may include a processor and a memory coupled with the processor, the processor configured to cause the apparatus to generate a MAC PDU for uplink transmission on configured uplink grant resources, the MAC PDU including at least one PDCP SDU of a group of logical channels; and cancel the uplink transmission of the MAC PDU on the configured uplink grant resources based at least in part on the MAC PDU includes only a predefined data type.

Additionally, the wireless communication at the device 502 may include any one or combination of the processor is configured to cause the apparatus to determine that the MAC PDU includes data that has exceeded a latency requirement. The processor is configured to cause the apparatus to determine that the MAC PDU includes data of a PDU set that has lost at least one PDU. The processor is configured to cause the apparatus to determine that the MAC PDU includes data that fails a QoS requirement. The processor is configured to cause the apparatus to determine that the MAC PDU includes the predefined data type based at least in part on a PDCP discard timer associated with PDCP SDUs multiplexed in the MAC PDU has expired. The processor is configured to cause the apparatus to determine that the MAC PDU includes the predefined data type based at least in part on an estimation that a PDCP discard timer will expire before a CG PUSCH transmission occasion. The processor is configured to cause the apparatus to transmit a signaling as a control message to a gNB on configured uplink resources in response to canceling the uplink transmission of the MAC PDU on the configured uplink grant resources. The signaling of the control message is transmitted via UCI or a MAC CE. The control message includes an indication that the configured uplink grant resources are unused. The indication is a cause value that indicates at least one of PSDB exceeded, PDU loss, or no data availability. The control message includes an indication that the MAC PDU includes only the predefined data type. The predefined data type is unused data based on one of exceeded a latency requirement, or lost at least one PDU of a PDU set. The processor is configured to cause the apparatus to flush a transmission buffer in response to canceling the uplink transmission of the MAC PDU on the configured uplink grant resources. The processor is configured to cause the apparatus to receive, from a gNB, a signaling as a transmission configuration indicating to skip a CG PUSCH transmission occasion of at least one of the predefined data type or a transport block that includes one of outdated data or obsolete data.

The processor 504 of the device 502, such as a UE 104, may support wireless communication in accordance with examples as disclosed herein. The processor 504 includes at least one controller coupled with at least one memory, and is configured to or operable to cause the processor to generate a MAC PDU for uplink transmission on configured uplink grant resources, the MAC PDU including at least one PDCP SDU of a group of logical channels; and cancel the uplink transmission of the MAC PDU on the configured uplink grant resources based at least in part on the MAC PDU includes only a predefined data type.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DoS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

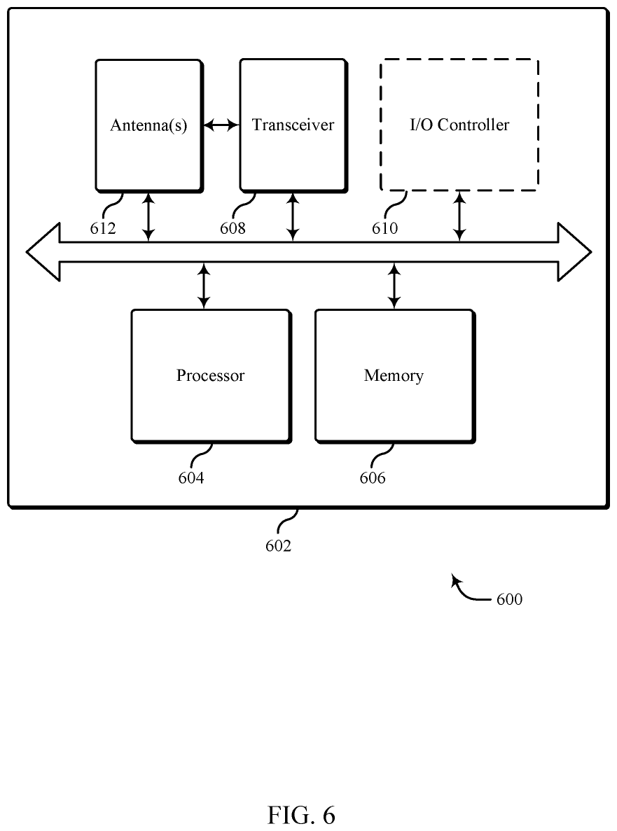

FIG. 6 illustrates an example of a block diagram 600 of a device 602 that supports unused transmission occasions usage in accordance with aspects of the present disclosure. The device 602 may be an example of a network entity 102 (e.g., a gNB, network equipment (NE)) as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for transmitting a first signaling to a UE as a transmission configuration indicating to skip a CG PUSCH transmission occasion of outdated data or obsolete data; and receiving a second signaling as a control message indicating that the UE canceled an uplink transmission of a MAC PDU on configured uplink grant resources based at least in part on the transmission configuration.

Additionally, the processor 604 may be configured as or otherwise support any one or combination of the second signaling of the control message is received via UCI or MAC CE in a first CG PUSCH transmission occasion. The control message includes an indication that the configured uplink grant resources are unused. The indication is a cause value that indicates at least one of PSDB exceeded, PDU loss, or no data availability. The control message includes an indication that the MAC PDU includes unused data based on the unused data has one of exceeded a latency requirement, or lost at least one PDU of a PDU set. The method further comprising scheduling one or more other uplink transmissions utilizing unused resources of the configured uplink grant resources. The one or more other uplink transmissions utilizing the unused resources of the configured uplink grant resources are scheduled for one of the UE or a different UE.

Additionally, or alternatively, the device 602, in accordance with examples as disclosed herein, may include a processor and a memory coupled with the processor, the processor configured to cause the apparatus to transmit a first signaling to a UE as a transmission configuration indicating to skip a CG PUSCH transmission occasion of outdated data or obsolete data; and receive a second signaling as a control message indicating that the UE canceled an uplink transmission of a MAC PDU on configured uplink grant resources based at least in part on the transmission configuration.

Additionally, the wireless communication at the device 602 may include any one or combination of the second signaling of the control message is received via UCI or a MAC CE in a first CG PUSCH transmission occasion. The control message includes an indication that the configured uplink grant resources are unused. The indication is a cause value that indicates at least one of PSDB exceeded, PDU loss, or no data availability. The control message includes an indication that the MAC PDU includes unused data based on the unused data has one of exceeded a latency requirement, or has lost at least one PDU of a PDU set. The processor is configured to cause the apparatus to schedule one or more other uplink transmissions utilizing unused resources of the configured uplink grant resources. The one or more other uplink transmissions utilizing the unused resources of the configured uplink grant resources are scheduled for one of the UE or a different UE.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DoS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

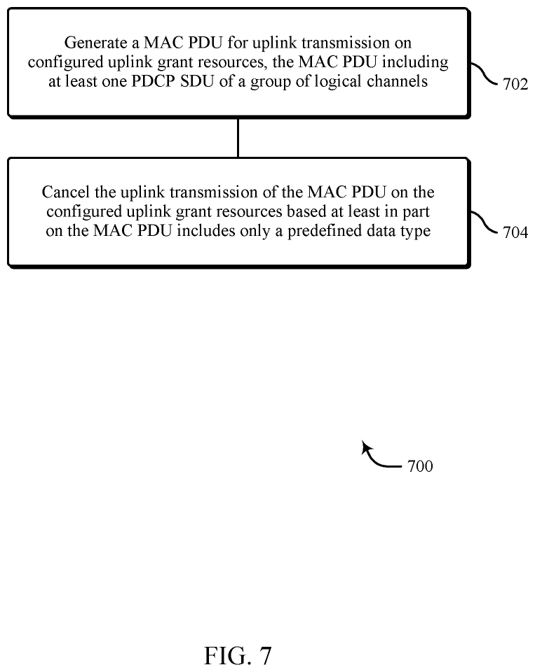

FIG. 7 illustrates a flowchart of a method 700 that supports unused transmission occasions usage in accordance with aspects of the present disclosure. The operations of the method 700 may be implemented by a device or its components as described herein. For example, the operations of the method 700 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include generating a MAC PDU for uplink transmission on configured uplink grant resources, the MAC PDU including at least one PDCP SDU of a group of logical channels. The operations of 702 may be performed in accordance with examples as described herein. In some implementations, aspects of the operations of 702 may be performed by a device as described with reference to FIG. 1.

At 704, the method may include canceling the uplink transmission of the MAC PDU on the configured uplink grant resources based at least in part on the MAC PDU includes only a predefined data type. The operations of 704 may be performed in accordance with examples as described herein. In some implementations, aspects of the operations of 704 may be performed by a device as described with reference to FIG. 1.

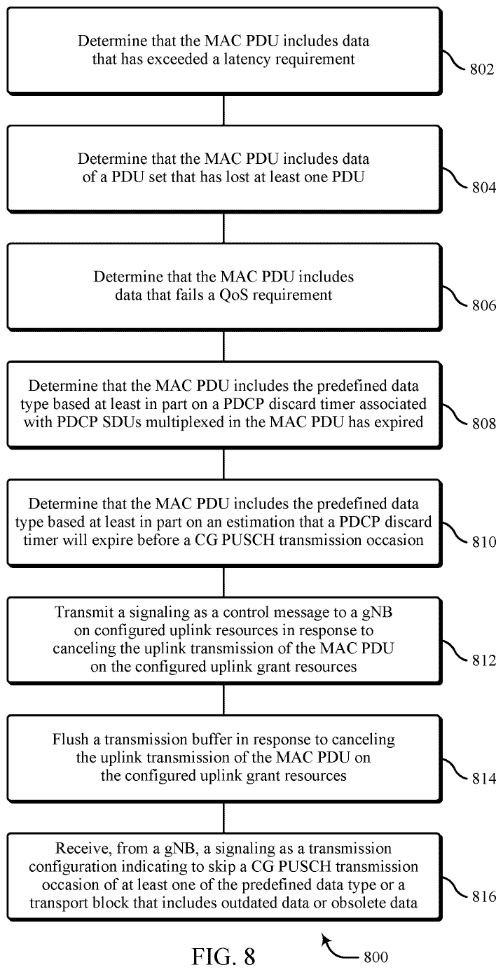

FIG. 8 illustrates a flowchart of a method 800 that supports unused transmission occasions usage in accordance with aspects of the present disclosure. The operations of the method 800 may be implemented by a device or its components as described herein. For example, the operations of the method 800 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include determining that the MAC PDU includes data that has exceeded a latency requirement. The operations of 802 may be performed in accordance with examples as described herein. In some implementations, aspects of the operations of 802 may be performed by a device as described with reference to FIG. 1.

At 804, the method may include determining that the MAC PDU includes data of a PDU set that has lost at least one PDU. The operations of 804 may be performed in accordance with examples as described herein. In some implementations, aspects of the operations of 804 may be performed by a device as described with reference to FIG. 1.

At 806, the method may include determining that the MAC PDU includes data that fails a QoS requirement. The operations of 806 may be performed in accordance with examples as described herein. In some implementations, aspects of the operations of 806 may be performed by a device as described with reference to FIG. 1.

At 808, the method may include determining that the MAC PDU includes the predefined data type based at least in part on a PDCP discard timer associated with PDCP SDUs multiplexed in the MAC PDU has expired. The operations of 808 may be performed in accordance with examples as described herein. In some implementations, aspects of the operations of 808 may be performed by a device as described with reference to FIG. 1.

At 810, the method may include determining that the MAC PDU includes the predefined data type based at least in part on an estimation that a PDCP discard timer will expire before a CG PUSCH transmission occasion. The operations of 810 may be performed in accordance with examples as described herein. In some implementations, aspects of the operations of 810 may be performed by a device as described with reference to FIG. 1.

At 812, the method may include transmitting a signaling as a control message to a gNB on configured uplink resources in response to canceling the uplink transmission of the MAC PDU on the configured uplink grant resources. The operations of 812 may be performed in accordance with examples as described herein. In some implementations, aspects of the operations of 812 may be performed by a device as described with reference to FIG. 1.

At 814, the method may include flushing a transmission buffer in response to canceling the uplink transmission of the MAC PDU on the configured uplink grant resources. The operations of 814 may be performed in accordance with examples as described herein. In some implementations, aspects of the operations of 814 may be performed by a device as described with reference to FIG. 1.

At 816, the method may include receiving, from a gNB, a signaling as a transmission configuration indicating to skip a CG PUSCH transmission occasion of at least one of the predefined data type or a transport block that includes one of outdated data or obsolete data. The operations of 816 may be performed in accordance with examples as described herein. In some implementations, aspects of the operations of 816 may be performed by a device as described with reference to FIG. 1.

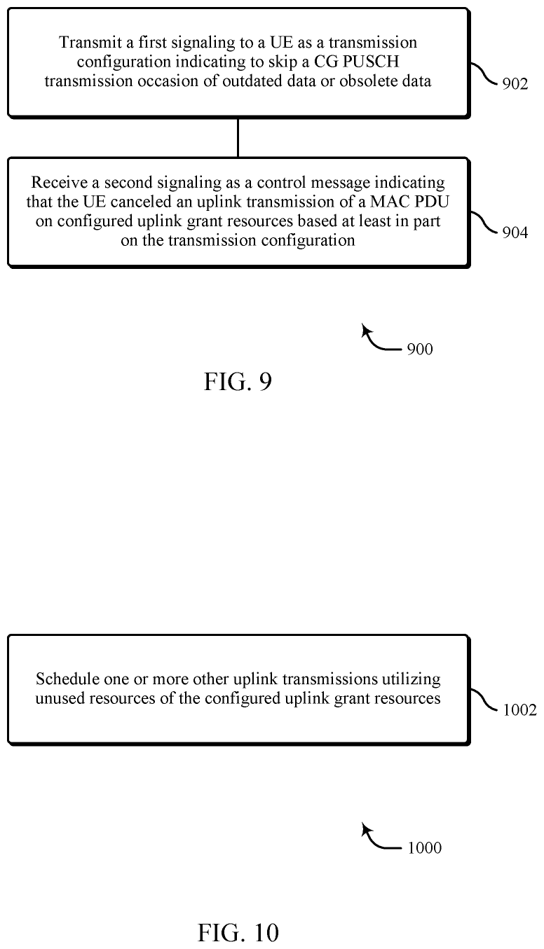

FIG. 9 illustrates a flowchart of a method 900 that supports unused transmission occasions usage in accordance with aspects of the present disclosure. The operations of the method 900 may be implemented by a device or its components as described herein. For example, the operations of the method 900 may be performed by a network entity 102 (e.g., a gNB) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include transmitting a first signaling to a UE as a transmission configuration indicating to skip a CG PUSCH transmission occasion of outdated data or obsolete data. The operations of 902 may be performed in accordance with examples as described herein. In some implementations, aspects of the operations of 902 may be performed by a device as described with reference to FIG. 1.

At 904, the method may include receiving a second signaling as a control message indicating that the UE canceled an uplink transmission of a MAC PDU on configured uplink grant resources based at least in part on the transmission configuration. The operations of 904 may be performed in accordance with examples as described herein. In some implementations, aspects of the operations of 904 may be performed by a device as described with reference to FIG. 1.

FIG. 10 illustrates a flowchart of a method 1000 that supports unused transmission occasions usage in accordance with aspects of the present disclosure. The operations of the method 1000 may be implemented by a device or its components as described herein. For example, the operations of the method 1000 may be performed by a network entity 102 (e.g., a gNB) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include scheduling one or more other uplink transmissions utilizing unused resources of the configured uplink grant resources. The operations of 1002 may be performed in accordance with examples as described herein. In some implementations, aspects of the operations of 1002 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
generate a medium access control (MAC) protocol data unit (PDU) for uplink transmission on configured uplink grant resources, the MAC PDU including at least one packet data convergence protocol (PDCP) service data unit (SDU) of a group of logical channels; and
cancel the uplink transmission of the MAC PDU on the configured uplink grant resources based at least in part on the MAC PDU includes only a predefined data type.

2. The UE of claim 1, wherein the at least one processor is operable to cause the UE to determine that the MAC PDU includes data that has exceeded a latency requirement.

3. The UE of claim 1, wherein the at least one processor is operable to cause the UE to determine that the MAC PDU includes data of a PDU set that has lost at least one PDU.

4. The UE of claim 1, wherein the at least one processor is operable to cause the UE to determine that the MAC PDU includes data that fails a quality of service (QoS) requirement.

5. The UE of claim 1, wherein the at least one processor is operable to cause the UE to determine that the MAC PDU includes the predefined data type based at least in part on a PDCP discard timer associated with PDCP SDUs multiplexed in the MAC PDU has expired.

6. The UE of claim 1, wherein the at least one processor is operable to cause the UE to determine that the MAC PDU includes the predefined data type based at least in part on an estimation that a PDCP discard timer will expire before a configured grant (CG) physical uplink shared channel (PUSCH) transmission occasion.

7. The UE of claim 1, wherein the at least one processor is operable to cause the UE to transmit a signaling as a control message to a next generation NodeB (gNB) on configured uplink resources in response to canceling the uplink transmission of the MAC PDU on the configured uplink grant resources.

8. The UE of claim 7, wherein the signaling of the control message is transmitted via uplink control information (UCI) or a MAC control element (CE).

9. The UE of claim 7, wherein the control message includes an indication that the configured uplink grant resources are unused.

10. The UE of claim 1, wherein the at least one processor is operable to cause the UE to flush a transmission buffer in response to canceling the uplink transmission of the MAC PDU on the configured uplink grant resources.

11. The UE of claim 1, wherein the at least one processor is operable to cause the UE to receive, from a next-generation NodeB (gNB), a signaling as a transmission configuration indicating to skip a configured grant (CG) physical uplink shared channel (PUSCH) transmission occasion of at least one of the predefined data type or a transport block that includes one of outdated data or obsolete data.

12. (canceled)

13. A network equipment (NE) for wireless communication, comprising:
at least one memory; and
at least one processor coupled with the at least one memory and operable to cause the NE to:
transmit a first signaling to a user equipment (UE) as a transmission configuration indicating to skip a configured grant (CG) physical uplink shared channel (PUSCH) transmission occasion of outdated data or obsolete data; and
receive a second signaling as a control message indicating that the UE canceled an uplink transmission of a medium access control (MAC) protocol data unit (PDU) on configured uplink grant resources based at least in part on the transmission configuration.

14. The NE of claim 13, wherein the second signaling of the control message is received via uplink control information (UCI) or a MAC control element (CE) in a first CG PUSCH transmission occasion.

15. The NE of claim 13, wherein the control message includes an indication that the configured uplink grant resources are unused.

16. The NE of claim 15, wherein the indication is a cause value that indicates at least one of PDU set delay budget (PSDB) exceeded, PDU loss, or no data availability.

17. The NE of claim 13, wherein the control message includes an indication that the MAC PDU includes unused data based on the unused data has one of exceeded a latency requirement, or lost at least one PDU of a PDU set.

18. The NE of claim 13, wherein the at least one processor is operable to cause the NE to schedule one or more other uplink transmissions utilizing unused resources of the configured uplink grant resources.

19. A method performed by a user equipment (UE), the method comprising:
generating a medium access control (MAC) protocol data unit (PDU) for uplink transmission on configured uplink grant resources, the MAC PDU including at least one packet data convergence protocol (PDCP) service data unit (SDU) of a group of logical channels; and
canceling the uplink transmission of the MAC PDU on the configured uplink grant resources based at least in part on the MAC PDU includes only a predefined data type.

20. The method of claim 19, further comprising determining that the MAC PDU includes at least one of:
data that has exceeded a latency requirement;
data of a PDU set that has lost at least one PDU; or
data that fails a quality of service (QoS) requirement.

21. A method performed by a network equipment (NE), the method comprising:
transmitting a first signaling to a user equipment (UE) as a transmission configuration indicating to skip a configured grant (CG) physical uplink shared channel (PUSCH) transmission occasion of outdated data or obsolete data; and
receiving a second signaling as a control message indicating that the UE canceled an uplink transmission of a medium access control (MAC) protocol data unit (PDU) on configured uplink grant resources based at least in part on the transmission configuration.
